(19) United States
(12) Patent Application Publication
(10) Pub. No.: US 2010/0059616 A1
(43) Pub. Date: Mar. 11, 2010

(54) RECORDING TAPE CARTRIDGE

(75) Inventor: Yasuhiro MORI, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/509,506

(22) Filed: Jul. 27, 2009

(30) Foreign Application Priority Data
Sep. 5, 2008 (JP) 2008-228843

(51) Int. Cl. G11B 23/107

(52) U.S. Cl. 242/348

(57) ABSTRACT

A recording tape cartridge is provided that prevents damage to a recording tape if it experiences a shock. The recording tape cartridge includes a reel on which a recording tape T is wound, an upper case and a lower case that form the case thereof, a reel accommodated between the upper case and lower case, and a compression coil spring that urges the reel against the lower case. An allowable lower limit value of the distance between the reel and the upper case is defined by the spring axial-direction length of the compression coil spring when it is most compressed.

### CROSS-REFERENCE TO RELATED APPLICATION

This application claims priority under 35 USC 119 from Japanese Patent Application No. 2008-228843, filed on Sep. 5, 2008, the disclosure of which is incorporated by reference herein.

### BACKGROUND

1. Technical Field

The present invention relates to a recording tape cartridge in which a reel having a recording tape wound thereon is rotatably accommodated in a case.

2. Related Art

Heretofore, a recording tape cartridge (magnetic tape cartridge) in which a recording tape (magnetic tape) used as a data recording/reproducing medium of a computer or the like is wound on a single reel and the reel is accommodated in a case, has been known. A leader member such as a leader block, a leader pin, or a leader tape is provided at the leading end of the recording tape. The leader member is pulled out from the recording tape cartridge by pullout means provided at a drive unit, and the recording tape fixed to the leader member is wound on a take-up reel provided at the drive unit.

In the conventional recording tape cartridge as above, the reel is movable in the case in the vertical direction (moves up and returns to its original position). Therefore, for example, when an operator inadvertently drops down the recording tape cartridge, it is possible that impact force to the recording tape cartridge causes deformation in outer peripheral portions of the reel flanges, with a distance between the reel flanges being reduced. Thus, a transverse-direction end portions (edges) of the recording tape adjacent to the outer peripheral portions of the reel flanges might be damaged. Incidentally, the same applies to the case of a recording tape cartridge in which two reels are accommodated in a case.

### SUMMARY

In view of the aforementioned circumstances, the present invention provides a recording tape cartridge that prevents damage to a recording tape if it experiences a shock.

A recording tape cartridge according to the present invention includes a reel on which a recording tape is wound; a case comprising a top plate and a bottom plate, between which the reel is accommodated; and a compression coil spring that urges the reel toward the bottom plate. An allowable lower limit value of a distance between the reel and the top plate being defined by an axial-direction length of the compression coil spring when the compression coil spring is most compressed.

### BRIEF DESCRIPTION OF THE DRAWINGS

Exemplary Embodiments of the present invention will be described in detail based on the following figures, wherein:

FIG. 1 is a schematic perspective view of a recording tape cartridge of a first embodiment;

FIG. 2 is a schematic exploded perspective view of the recording tape cartridge according to the first embodiment when seen from the upper side thereof;

FIG. 3 is a schematic exploded perspective view of the recording tape cartridge according to the first embodiment when seen from the lower side thereof;

FIG. 4A is a side cross sectional view of the recording tape cartridge in a state in which a reel is locked so as not to rotate in the first embodiment;

FIG. 4B is a side cross sectional view of the recording tape cartridge in a state in which a compression coil spring is tightly compressed in the spring axial direction in the first embodiment;

FIG. 5A is a side cross sectional view of the recording tape cartridge in a state in which a reel is locked so as not to rotate in a modified example of the first embodiment;

FIG. 5B is a side cross sectional view of the recording tape cartridge in a state in which a compression coil spring is tightly compressed in the spring axial direction in a modified example of the first embodiment;

FIG. 6A is a side cross sectional view of a compression coil spring in a state in which a reel is locked so as not to rotate in a second embodiment; and

FIG. 6B is a side cross sectional view of a compression coil spring in a state in which the compression coil spring is tightly compressed in the spring axial direction in the second embodiment.

### DETAILED DESCRIPTION

The best mode of embodiments of the present invention is hereinafter described in detail with reference to the attached drawings. Note that in a second embodiment of the present invention, the same constitutional elements as those that have been already described are denoted by the same reference numbers, respectively, and a description thereof is omitted.

### First Embodiment

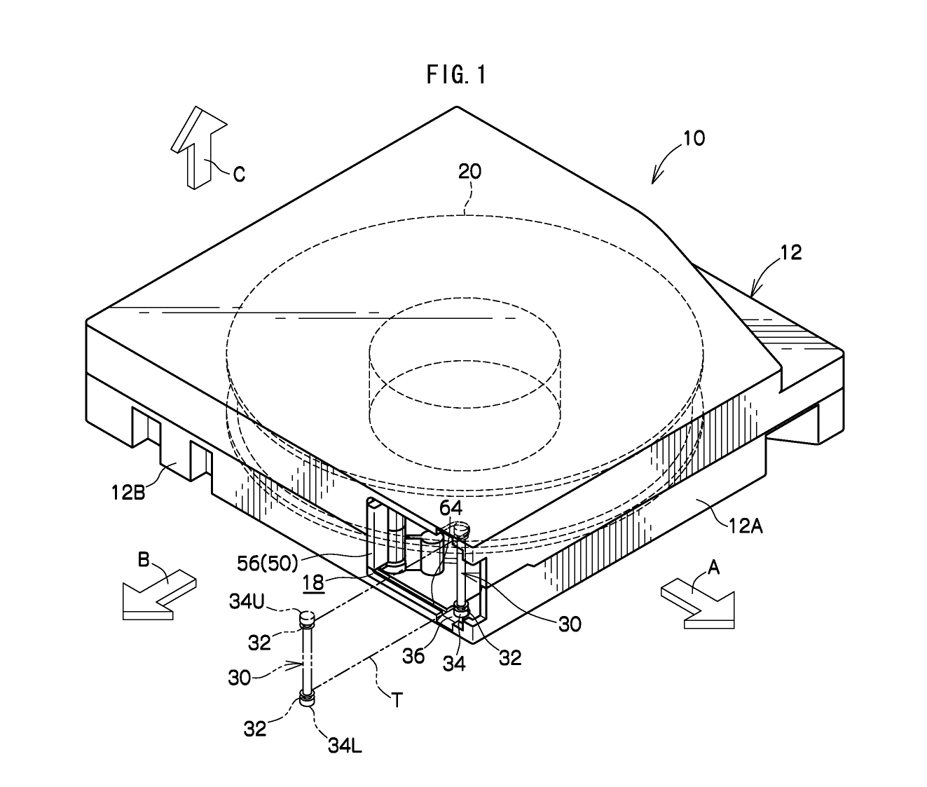

First, a first embodiment of the invention is described. For convenience of explanation, in FIG. 1, the direction in which a recording tape cartridge 10 described in the present embodiment is loaded into a drive unit is indicated by arrow A, which direction is made to coincide with the forward direction (front side) of the recording tape cartridge 10. The direction orthogonal to the direction indicated by arrow A is indicated by arrow B, which direction is made to coincide with the rightward direction (right side) of the recording tape cartridge 10. Further, the direction orthogonal to the direction indicated by arrow A and also orthogonal to the direction indicated by arrow B is indicated by arrow C, and the direction indicated by arrow C is made to coincide with the upward direction (upper side) of the recording tape cartridge 10. At the beginning, the recording tape cartridge 10 is described.

(Overall Structure of Recording Tape Cartridge)

As shown in FIGS. 1 to 3, the recording tape cartridge 10 has a substantially rectangular case 12. This case 12 is formed by means of ultrasonic welding, screw fastening, or the like of an upper case 14 and a lower case 16 made of resin of polycarbonate (PC) or the like, in a state in which a peripheral wall 14B made upright at the peripheral edge of an upper plate 14A and a peripheral wall 16B made upright at the peripheral edge of a bottom plate 16A are caused to abut against each other.

In other words, vis bosses 15 are formed respectively in vicinities of corners of each of the upper case 14 and the lower base 16, and vises (not shown) are screwed in the vis bosses 15, respectively, from the bottom surface side of the lower case 16, such that the case 12 is assembled. Then, a single reel 20 is rotatably accommodated within the case 12.

The reel 20 is formed in such a manner that a cylindrical reel hub 22 having a bottom and forming the shaft center portion and a lower flange 26 provided at the lower end portion of the reel hub 22 are formed integrally, and an upper flange 24 is attached to the upper end portion of the reel hub 22 by means of ultrasonic welding. Then, a recording tape T such as a magnetic tape, serving as an information recording/reproducing medium, is wound on and around the outer peripheral surface of the reel hub 22, and the upper flange 24 and lower flange 26 holds the transverse-direction end portions of the wound recording tape T.

Further, a reel gear 44 is annularly on the lower surface (outer surface) of the bottom wall (bottom portion) 28 of the reel hub 22. A gear opening 40 is formed at the central portion of the lower case 16 so as to allow the reel gear 44 to be exposed to the outside. The reel gear 44 exposed from the gear opening 40 is driven to rotate by meshing with a drive gear (not shown) formed on the rotating shaft (not shown) of a drive unit. As a result, the reel 20 in the case 12 can be rotated relative to the case 12.

A reel plate 46 that is an annular metal plate comprised of magnetic material is fixed coaxially and integrally with the reel gear 44 formed on the lower surface of the bottom wall 28 at an inner side in the radial direction of the reel gear 44 by means of insert molding. The reel plate 46 is attracted and held due to magnetic force of an annular magnet (not shown) provided on the rotating shaft of the drive unit. In addition, the reel 20 is made to partially project toward the respective inner surfaces of the upper case 14 and the lower case 16, and the reel is held firmly by free-motion regulating walls 42 serving as inner walls on a circular track coaxial with the gear opening 40.

Further, an opening 18 is formed on the rightward wall 12B of the case 12, and the recording tape T wound on the reel 20 is pulled out from the opening 18. A leader pin 30 that is pulled out while it is being fastened by (engaged with) a pull-out member (not shown) of the drive unit is fixed at a free end of the recording tape T to be pulled out from the opening 18. Annular grooves 32 are formed respectively at both ends of the leader pin 30 projecting from the transverse-direction end portions of the recording tape T, respectively, and are fastened by a hook of the pull-out member, or the like. This leads to formation of the structure in which, when the recording tape T is pulled out, the hooks or the like should not come into contact with and damage the recording tape T.

Still further, upper and lower pin holding portions 36 that make a pair are provided at the inner side of the opening 18 of the case 12, that is to say, on the inner surface of the top plate 14A of the upper case 14 and also on the inner surface of the bottom plate 16A of the lower case 16, and these pin holding portions 36 are used to locate and hold the leader pin 30 in the case 12. These pin holding portions 36 are formed into a substantially semicircular shape, and the side of the pin holding portions 36 at which the recording tape T is pulled out is opened. Both end portions 34L, 34U of the leader pin 30 provided in the upright state can move in and out from the pin holding portions 36 at the open sides thereof.

A plate spring 38 is disposed fixedly in the vicinity of the pin holding portions 36, and respective ends of two arm sections 108L, 108U that form the plate spring 38 are engaged with the upper and lower end portions 34L, 34U of the leader pin 30, respectively, so that the leader pin 30 is adapted so as to be held by the pin holding portions 36 (i.e., pullout resistance is imparted). In a case in which the leader pin 30 moves in and out from the pin holding portions 36, the arm sections 108L, 108U is made to appropriately elastically deform to allow movement of the leader pin 30.

The opening 18 is opened and closed by a door 50. The door 50 is formed into a substantially rectangular plate of such a size that allows the opening 18 to be closed. Groove portions 64 are formed on the top plate 14A and the bottom plate 16A, respectively, at the inner side of the opening 18 so that the door 50 can move along the rightward wall 12B of the case 12, and upper and lower end portions of the door 50 are fit into the groove portions 64 in a slidable manner.

Furthermore, a shaft 52 is made to project from the center of a rear end portion of the door 50, and a coil spring 58 is put and fit on the shaft 52. An extended opening portion 54 is formed at the rear end of the shaft 52 so as to prevent dropout of the coil spring 58. The lower case 16 is provided with a support 60 having an engagement/stopping portion 62 that engages with and stops the rear end of the coil spring 58 put and fit on the shaft 52.

Accordingly, the door 50 is structured in such a manner that the shaft 52 is supported slidably on the support 60, and as the rear end of the coil spring 58 is engaged with and stopped by the engagement/stopping portion 62, the door 50 is constantly urged in a direction in which the opening 18 is closed due to the urging force of the coil spring 58. Incidentally, it is preferable that, when the opening 18 is opened, a support 66 that supports the shaft 52 is further provided so as to project at the rear side of the support 60.

Further, a convex portion 56 used for the opening/closing operation of the door is made to project toward the outside at the front end portion of the door 50. The convex portion 56 is engaged with an opening/closing member (not shown) at the side of the drive unit accompanied by loading of the recording tape cartridge 10 into the drive unit. As a result, the door 50 is formed so as to be opened against the urging force of the coil spring 58.

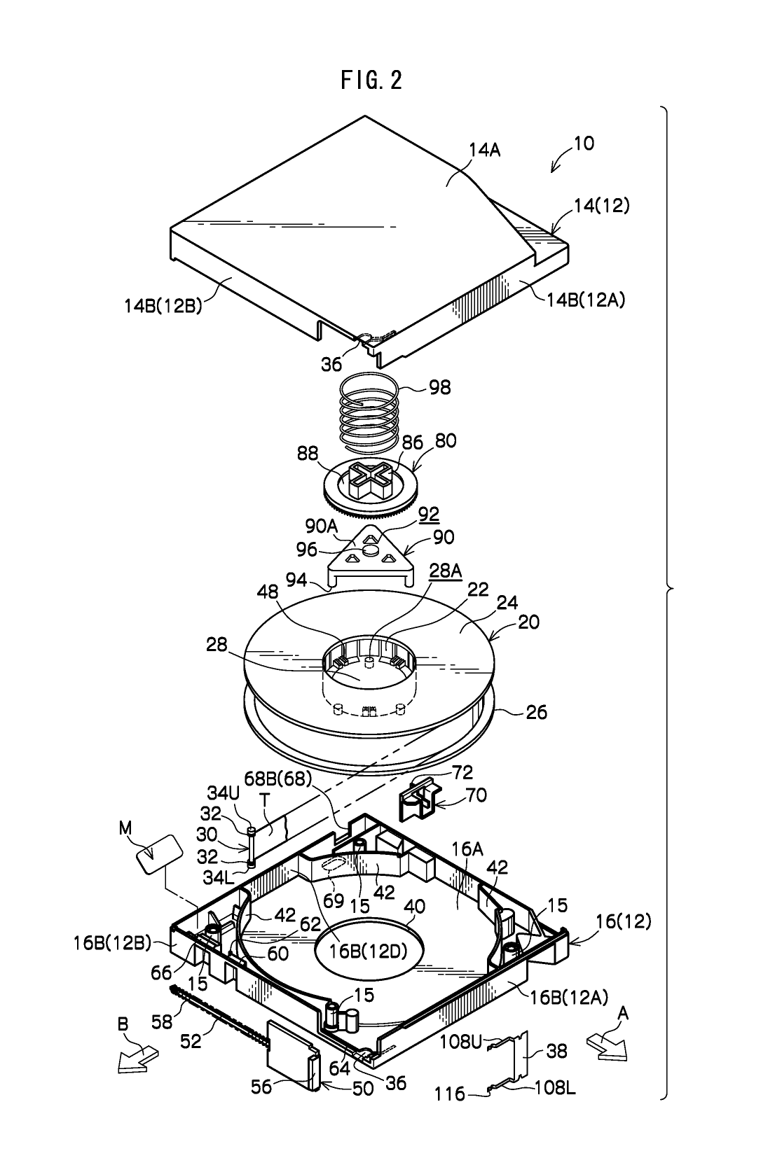

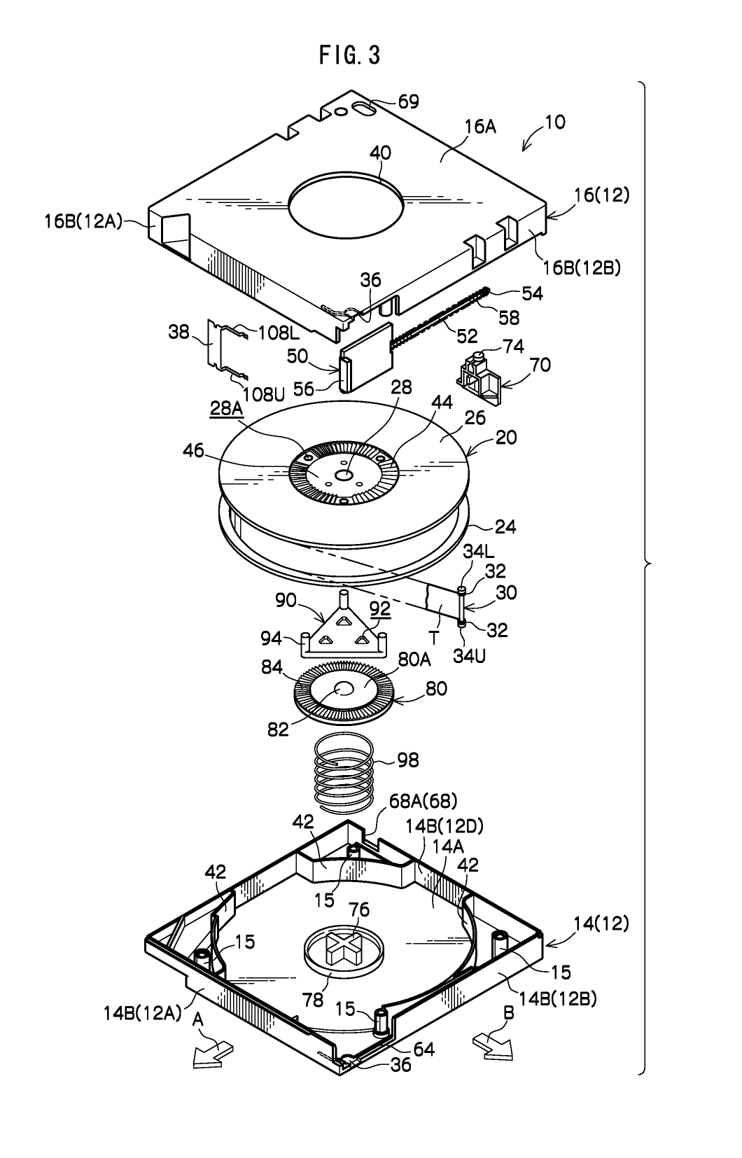

As shown in FIGS. 2 and 3, a write protect 70 having a mechanism in which recording on the recording tape T is allowed or inhibited, is provided at the left rear portion of the case 12 in such a manner as to be slidable in the horizontal direction. An opening 68 from which an operating projection 72 used for manual operation of the write protect 70 is formed on a rear wall 12D of the case 12. The opening 68 is formed by, when the upper case 14 and the lower case 16 are joined together, a notch portion 68A formed on the peripheral wall 14B of the upper case 14, and a notch portion 68B formed on the peripheral wall 16B of the lower case 16.

Furthermore, an elongated hole 69 that allows a protruding portion 74 of the write protect 70 to be exposed to the outside, is formed so as to extend horizontally in the lower case 16. When the recording tape cartridge 10 is loaded in the drive unit, the position of the write protect 70 is detected at the side of the drive unit, such that whether the recording on the recording tape T is allowed or inhibited may be automatically determined. There is no possibility that the protruding portion 74 may come out from the lower surface of the lower case 16. Further, as shown in FIG. 2, a memory board M having various information such as memory capacity, recording mode and the like stored thereon is disposed at the right rear portion of the case 12 at a predetermined angle of inclination.

As shown in FIGS. 2 and 3, plural (for example, three) engagement gears 48 are upright at predetermined intervals (for example, at the same intervals of an angle of 120 degrees) on the upper surface peripheral edge of the bottom wall 28 of the reel hub 22. Plural (in this case, three) through holes 28A are formed between adjacent engagement gears 48 at predetermined positions (in this case, at intervals of an angle of 120 degrees) on the reel gear 44. A circular plate-shaped brake member 80 made of resin material is inserted inside of the reel hub 22.

A brake gear 84 that can mesh with the engagement gears 48 is formed annularly at the peripheral edge of the lower surface 80A of the brake member 80. An engagement projection 86 having a substantially cross-shaped configuration when seen from the top is upright on the upper surface of the brake member 80. A rotation-regulating rib 76 having a substantially cross-shaped configuration when seen from the top projects downward from the inner surface of the top plate 14A of the upper case 14. The length of the engagement projection 86 is slightly greater than that of a rotation-regulating rib 76 and the rotation-regulation rib 76 is inserted within the engagement projection 86. Consequentially, the brake member 80 is non-rotatable with respect to the case 12 (upper case 14), and is movable in the vertical direction within the reel hub 22.

Further, a compression coil spring 98 is provided between the upper case 14 and the brake member 80. That is to say, one end of the compression coil spring 98 abuts against the inner side of an annular projection 78 (i.e., a region between the rotation-regulating rib 76 and the annular projection 78) that projects at the outer side of the rotation-regulating rib 76 of the upper case 14, and the other end of the compression coil spring 98 is located so as to abut against the inner side of the annular groove 88 provided on the upper surface of the brake member 80. Due to the urging force of the compression coil spring 98, the brake member 80 is constantly urged downward. In the present embodiment, the compression coil spring 98 has a shape that conforms to the outer periphery of a cylinder.

Accordingly, when the recording tape cartridge 10 is not in use (when it is not loaded in the drive unit), the brake gear 84 meshes with the engagement gears 48, thereby effecting a rotation-locked state in which relative rotation of the reel 20 with respect to the case 12 is stopped. At this time, the reel 20 is pushed against the lower case 16 side due to the urging force, and the reel gear 44 is exposed to the outside from the gear opening 40.

Further, a release member 90 having the shape of regular triangle when seen from the top and made of resin material is inserted in the reel hub 22 and also below the brake member 80 (in a region between the bottom wall 28 and the brake member 80). The release member 90 includes plural (in the drawings, three) through holes 92 having a predetermined shape (in the drawings, a hexagonal configuration) at proper positions, so that reduction of weight of the release member 90 is achieved. The release member 90 includes leg portions 94 on the lower surface thereof at the respective apex portions. The leg portions 94 are inserted in the through holes 28A, respectively, and project from the lower surface of the bottom wall 28 by a predetermined length to the reel gear 44.

A flat surface-shaped support convex portion 96 is formed at the center of the upper surface 90A of the release member 90. A substantially semispherical release projection 82 projecting from the center of the lower surface 80A of the brake member 80 is adapted so as to abut against the support convex portion 96 (see FIGS. 2 and 3). As a result, the area with the brake member 80 and the release member 90 coming into contact with each other is decreased, and the sliding resistance when in use (when the reel 20 rotates) is reduced. As material of the brake member 80, for example, polyacetal (POM) is used, and as material of the release member 90, for example, polybutylene terephthalate (PBT) is used.

### (Operation and Effects)

In the recording tape cartridge 10 structured as above, the operation and effects thereof are described hereinafter. When the recording tape cartridge 10 is not in use (at the time of storage, transportation or the like), the opening 18 of the recording tape cartridge 10 is closed by the door 50. Due to the urging force of the compression coil spring 98, the brake member 80 is located at the rotation-locked position to cause the brake gear 84 to mesh with the engagement gears 48. For this reason, the reel 20 is prevented from rotating with respect to the case 12.

In the case in which the recording tape T is in use, the recording tape cartridge 10 is loaded in the drive unit along the direction indicated by arrow A with the front wall 12A serving as the head. The opening/closing member provided at the side of the drive unit engages with the convex portion 56 of the door 50. In this state, as the recording tape cartridge 10 is further moved in the direction of arrow A, the opening/closing member moves the convex portion 56 relatively in the rearward direction against the urging force of the coil spring 58. Then, the door 50 in which the convex portion 56 is provided slides rearward within the groove portion 64 along the rightward wall 12B, and the opening 18 is thereby opened.

In this way, when the recording tape cartridge 10 is loaded in the drive unit to a predetermined depth and the opening 18 is completely opened, the recording tape cartridge 10 moves downward to a predetermined height position, and a positioning member (not shown) of the drive unit is inserted in a positioning hole portion (not shown) formed in the lower case 16. As a result, the recording tape cartridge 10 is correctly positioned at a predetermined position in the drive unit, so that further sliding movement (rearward movement) of the door 50 is restrained.

Further, due to downward movement of the recording tape cartridge 10, the rotating shaft enters relatively from the gear opening 40 to cause the drive gear to mesh with the reel gear 44. Then, accompanied by the operation of the drive gear meshing with the reel gear 44, the leg portions 94 projecting on the reel gear 44 are pushed up against the urging force of the compression coil spring 98, and the brake member 80 is pushed upward via the release member 90, thereby causing meshing of the brake gear 84 with the engagement gear 28 to be released.

When the drive gear and the reel gear 44 completely mesh with each other, the reel plate 46 is attracted and held by magnetic force of an annular magnet provided at the inner side of the drive gear. Thus, meshing of the reel gear 44 with the drive gear is maintained, and the reel 20 is brought into the locking-released state in which the reel becomes rotatable relatively with respect to the case 12 within the case.

At the same time, a pullout member provided at the drive unit enters into the case 12, and holds the leader pin 30 positioned and held in the pin holding portions 36, and further exerts pullout force on the pin holding portions 36. As a result, the arm sections 108L, 108U deform in the direction of arrow A (in the forward direction), and the leader pin 30 is pulled out. At this time, the recording tape cartridge 10 is correctly positioned within the drive unit, and therefore, the pullout member reliably allows the hook to be engaged in the annular grooves 32 of the leader pin 30. Further, the reel 20 is released from the rotation-locked state, and therefore, the reel 20 can rotate together with the pullout operation of the leader pin 30.

In this manner, the leader pin 30 pulled out from the opening 18 is accommodated in a take-up reel (not shown). Due to the take-up reel and the reel 20 being driven to rotate synchronously, the recording tape T is pulled out sequentially from the case 12 while it is being taken up on the take-up reel, and a recording/reproducing head (not shown) located along a predetermined tape path allows recording or reproduction of information.

In a case in which the recording tape cartridge 10 after recording or reproduction of information has been finished is removed from the drive unit, the rotating shaft rotates reversely, thereby causing the recording tape T to be wound back to the reel 20. Then, as the recording tape T is completely wound back to the reel 20 and the leader pin 30 makes the arm sections 108L, 108U to be bent and deformed in the forward direction.

As the leader pin 30 is accommodated in the accommodation position at the pin holding portion 36, the leader pin 30 returns to the state before it is pulled out due to the urging force generated by bending deformation of the arm sections 108, and the leader pin 30 is pressed against the inner wall of the pin holding portion 36 and held stably.

When the leader pin 30 is held in the pin holding portion 36, the recording tape cartridge 10 moves upward to a predetermined height position, and the positioning member is pulled out from the positioning hole portion, and at the same time, the rotating shaft is pulled out from the gear opening 40, so that the state with the drive gear meshing with the reel gear 44 is released.

Due to the urging force of the compression coil spring 98, the brake member 80 and the release member 90 are pressed downward, and the leg portions 94 are inserted through the through holes 28A, respectively, and made to project from the lower surface of the bottom wall 28 by a predetermined length on the reel gear 44. At the same time, the brake gear 84 meshes with the engagement gear 48. Accordingly, the reel 20 is again brought into the rotation-locked state in which the relative rotation thereof within the case 12 is stopped, and subsequently, the recording tape cartridge 10 is moved by an eject mechanism (not shown) in a direction opposite to that of arrow A.

Accompanied by the aforementioned movement, the door 50 slides in the direction in which the opening 18 is closed, due to the urging force of the compression coil spring 58, so as to completely close the opening 18 (the opening 18 returns to its initial state). In this way, the relative rotation of the reel 20 with respect to the case 12 is locked, and the recording tape cartridge 10 with the opening 18 being closed is completely removed from the drive unit.

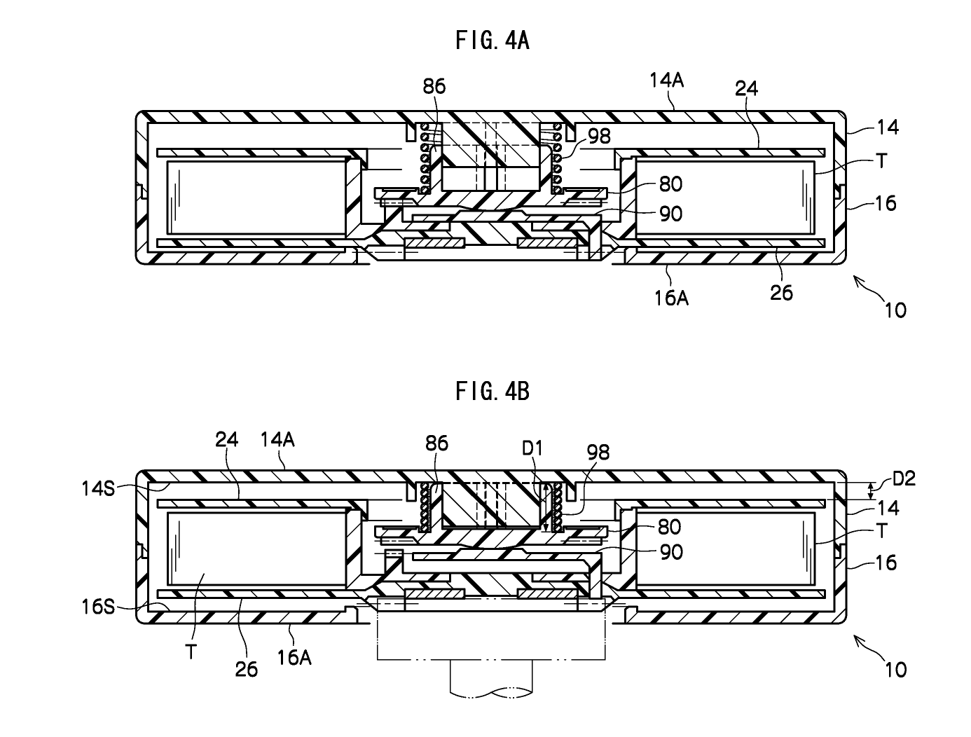

In the recording tape cartridge 10 that enables the aforementioned operation, when the recording tape cartridge 10 is not in use and the reel 20 is in the rotation-locked state, the compression coil spring 98 is made elongated to the longest in the case 12 (see FIG. 4A).

When the recording tape cartridge 10 is in use and the reel 20 is released from the rotation-locked state, the compression coil spring 98 is contracted due to the pressing force from the drive unit.

Further, in the present embodiment, the axial-direction length of the compression coil spring 98 when it is most contracted is, as shown in FIG. 4B, a spring axial-direction length D1, at which time the compression coil spring 98 is tightly compressed in the axial direction of the spring. In the present embodiment, an allowable lower limit value D2 of the distance between the reel 20 and the top plate 14 in the aforementioned case (that is to say, the distance between the upper surface of the upper flange 24 and the top plate inner wall 14S) is defined. Due to the allowable lower limit value D2 being defined, even if the recording tape cartridge 10 experiences a shock due to it being dropped or the like, the upper case 14 does not come into contact with the upper flange 24, or a shock exerted from the upper case 14 to the upper flange 24 is alleviated, thereby preventing the transverse-direction end (edge) of the recording tape T from being damaged.

Herein, the spring axial-direction length D1 when the compression coil spring 98 is tightly compressed in the axial direction of the spring is preferably equal to or slightly greater than the height of the engagement projection 86.

Herein, the spring constant of the compression coil spring 98 is set at a proper value. In other words, modulus of transverse elasticity of spring wire, wire diameter, number of active coils, average coil diameter and the like are determined so that a preferred state is made either when the recording tape cartridge is not in use and the reel 20 is brought into the rotation-locked state, or when the recording tape cartridge is in use and the reel 20 is released from the rotation-locked state.

As described above, in the present embodiment, due to the dimensions of the compression coil spring 98, and the like being made desired, the allowable lower limit value D2 of the distance between the reel 20 and the upper flange 24 can be defined without causing an increase in the number of parts. Then, due to the aforementioned value being defined, even if the recording tape cartridge 10 experiences a shock, such as dropout, the tape edge portions of the recording tape T are not damaged.

The aforementioned allowable lower limit value may be defined in consideration of reel outer diameter, case structure, case wall thickness and the like.

Further, the compression coil spring 98 has a shape that conforms to the outer periphery of a cylinder, so that the compression coil spring 98 does not protrude from the annular groove 88 of the brake member 80 in the horizontal direction. Accordingly, the structure of the compression coil spring 98 is simple and it is difficult to form any wasted space within the recording tape cartridge 10.

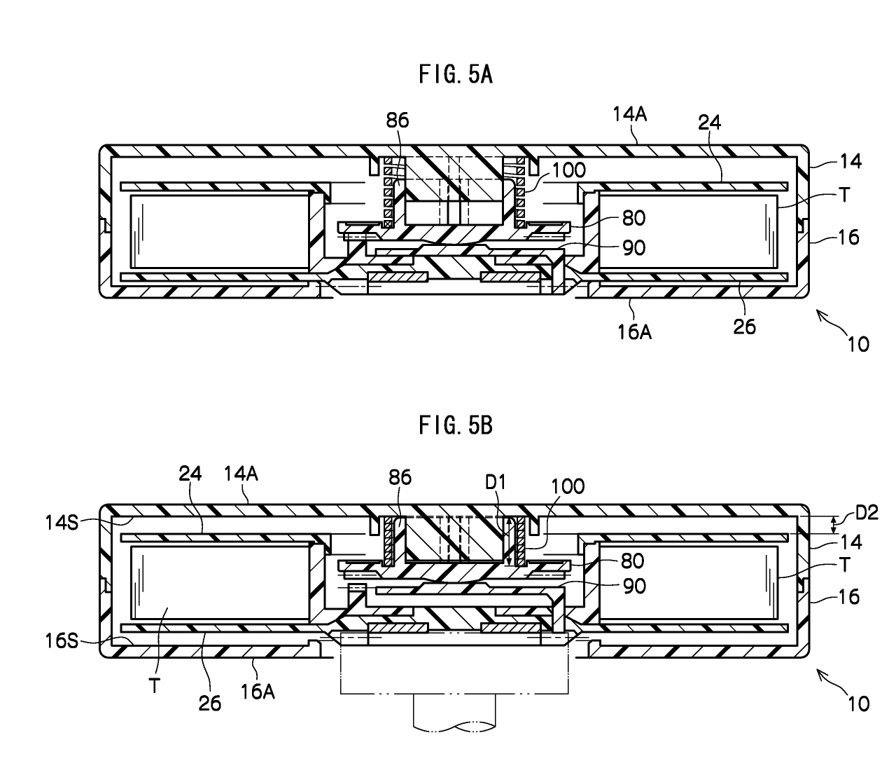

Incidentally, as shown in FIGS. 5A and 5B, in place of the compression coil spring 98, a compression coil spring 100 formed by a wire having a square shape in a cross section may also be provided. As a result, when the compression coil spring 100 is most compressed, compression coil spring sections adjacent in the case thickness direction can be made to come into surface-contact with each other, thereby leading to further contact stabilization of the compression coil spring.

### Second Embodiment

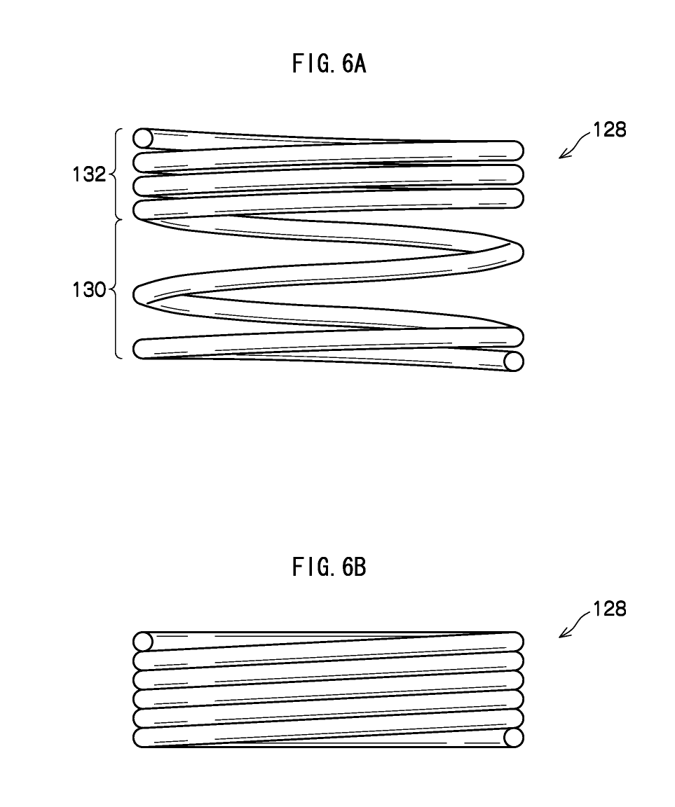

Next, a second embodiment of the invention is described. As shown in FIGS. 6A and 6B, in this embodiment, in place of the compression coil spring 98 provided in the first embodiment, a compression coil spring 128 is provided in the recording tape cartridge.

The compression coil spring 128 includes a loosely wound section 130 and a tightly wound section 132. Herein, the loosely wound section 130 means a section in which the number of turns per unit of length in the axial direction of the spring is small, and the tightly wound section 132 means a section in which the number of turns per unit of length in the axial direction of the spring is large. The spring axial length of the loosely wound section 130 and the spring axial length of the tightly wound section 132 are adjusted in advance so that a predetermined spring constant of the compression coil spring 128 is obtained. Accordingly, in a case in which the compression coil spring 128 is manufactured based on the present embodiment, it is easy to set the spring constant of the compression spring 128 to a desired value even if the wire diameter of the spring, the number of turns, and the like are changed.

As mentioned above, the embodiments of the present invention are described by way of practical examples, but the embodiments as above are examples only, and each can come into effect by being changed in various ways without departing from the scope of the invention.

For example, the first and second embodiments are described above by using the example in which the compression coil spring has a shape that conforms to the outer periphery of a cylinder. However, the present invention is not limited to the above, and the compression coil spring may also have a shape that conforms to the outer periphery of a square-shaped cylinder, and further may have a shape that conforms to a cylinder having the outer periphery of a polyhedral cylinder.

Further, in the first and second embodiments, the example with one compression coil spring being used is described, but plural compression coil springs may also be provided.

Moreover, in the second embodiment, as shown in FIGS. 6A and 6B, the compression coil spring 128 having the upper section serving as the loosely wound section 130 and the middle and lower sections each serving as the tightly wound section 132 is illustrated by way of example. However, the upper and lower section of the compression coil spring may be the loosely wound sections and the middle wound section is the tightly wound section. Alternatively, a large number of loosely wound sections and tightly wound sections may also be formed in the compression coil spring body.

Still further, the first and second embodiments each illustrate the example in which a single reel is accommodated in the case, but even when a two-reel type recording tape cartridge having two reels accommodated in the case is used, the effects of the present invention can be achieved.

Needless to say, the scope of the claims of the present invention should not be limited to these embodiments.

What is claimed is:

1. A recording tape cartridge comprising:
a reel on which a recording tape is wound;
a case comprising a top plate and a bottom plate, between which the reel is accommodated; and
a compression coil spring that urges the reel toward the bottom plate,
an allowable lower limit value of a distance between the reel and the top plate being defined by an axial-direction length of the compression coil spring when the compression coil spring is most compressed.

2. The recording tape cartridge according to claim 1, wherein the compression coil spring comprises a wire having a square shape in a cross section.

3. The recording tape cartridge according to claim 1, wherein the compression coil spring comprises a loosely wound section and a tightly wound section.

4. The recording tape cartridge according to claim 3, wherein the loosely wound section is formed in an upper section of the compression coil spring at the side of the top plate of the case and the tightly wound section is formed in a lower section of the compression coil spring at the side of the bottom plate of the case.

5. The recording tape cartridge according to claim 3, wherein the loosely wound section comprises an upper loosely wound section formed in an upper section of the compression coil spring at the side of the top plate of the case, and a lower loosely wound section formed in a lower section of the compression coil spring at the side of the bottom plate, and
the tightly wound section is formed at an intermediate region of the compression coil spring between the upper loosely wound section and the lower loosely wound section.

6. The recording tape cartridge according to claim 1, wherein a plurality of compression coil springs are provided.

7. The recording tape cartridge according to claim 1, wherein the top plate of the case has a rotation-regulating rib that projects toward the reel, and
the recording tape cartridge further comprises a brake member that moves vertically between the top plate of the case and the reel to brake the reel and that has an engagement projection in which the rotation-regulating rib is inserted.

8. The recording tape cartridge according to claim 7, wherein the engagement projection is upright, such that the height of the engagement projection is greater than that of the rotation-regulating rib.

9. The recording tape cartridge according to claim 7, wherein an axial-direction length of the compression coil spring when the compression coil spring is most compressed is equal to or greater than the height of the engagement projection.
